(19) United States
(12) Patent Application Publication
(10) Pub. No.: US 2023/0106967 A1
(43) Pub. Date: Apr. 6, 2023

(54) SYSTEM, METHOD AND USER EXPERIENCE FOR SKEW DETECTION AND CORRECTION AND GENERATING A DIGITIZED MENU

(71) Applicant: SleekText Inc., San Francisco, CA (US)

(72) Inventors: Gaurav Aggarwal, San Francisco, CA (US); Spandana Nakka, San Francisco, CA (US); Ankush Chaudhari, Surat (IN); Soham Bose, Irvine, CA (US)

(73) Assignee: SleekText Inc.

(21) Appl. No.: 17/492,507

(22) Filed: Oct. 1, 2021

(51) Int. Cl. G06K 9/00; G06K 9/32; G06K 9/62; G06Q 50/12

(52) U.S. Cl. CPC G06K 9/00456; G06K 9/3275; G06K 9/6218; G06K 9/00463; G06K 9/00469; G06K 9/6215; G06Q 50/12; G06K 2209/01

(57) ABSTRACT

A computer-implemented method for automatically generating a digitized menu, the computer-implemented method comprising: receiving an image associated with a non-digitized menu; performing an optical character recognition (OCR) operation on the received image, to identify characters and strings of characters comprising one or more words, to generate a text-readable document; determining whether the received image is skewed to generate a determination; for the determination providing an indication that the received image is skewed, performing skew detection and skew correction; clustering the identified characters and strings of characters to generate a clustered text-readable document; classifying the clusters, and associating the classified clusters to generate a classified, associated text-readable document; and for one or more items on the classified, associated text-readable document, obtaining an associated image; and providing the digitized menu comprising the associated image and the classified, associated text-readable document.

### BACKGROUND

### Field

The present disclosure relates to systems, methods and user experiences associated with the detecting and correcting skew in an image associated with a menu, and generating a digitized menu.

### Related Art

In related art systems, a user, such as a commercial vendor operating a facility such as a restaurant, may wish to provide a menu that provides options in an accurate, organized and user-friendly manner. For example, a restauranteur may wish to update an existing menu to associate images with items on the menu, or may even wish to produce an entirely new menu, rather than updating an existing menu.

Related art approaches to updating a menu may include a manual process for reviewing existing menu information, scanning or taking a photograph of the menu information, and then correcting skew, either by manual manipulation or by well-known techniques. Further, the photograph may be selected using well-known techniques such as deep learning.

However, the related art approaches have various problems and disadvantages. For example, but not by way of limitation, the related art approaches to skew correction may not provide a sufficiently accurate result. Further, the related art approaches to image selection may not produce or provide a photo that is most closely associated with the menu item. For example, but not by way of limitation, related art deep learning approaches are heavily dependent on the dataset which it is trained on. Thus, these related art approaches do not perform well on an unknown dataset of menus.

Thus, there is an unmet need for an approach that can accurately generate a digitized menu while taking into consideration the need for accurate skew detection and correction, as well as the need to generate a menu that is not dependent on training data for menu generation, including the generation of the image for a menu item.

### SUMMARY OF THE DISCLOSURE

Aspects of the example implementations are directed to a computer-implemented method for automatically generating a digitized menu, the computer-implemented method comprising receiving an image associated with a non-digitized menu; performing an optical character recognition (OCR) operation on the received image, to identify characters and strings of characters comprising one or more words, to generate a text-readable document; determining whether the received image is skewed to generate a determination; for the determination providing an indication that the received image is skewed, performing skew detection and skew correction; clustering the identified characters and strings of characters to generate a clustered text-readable document; classifying the clusters, and associating the classified clusters to generate a classified, associated text-readable document; and for one or more items on the classified, associated text-readable document, automatically obtaining an associated image; and providing the digitized menu comprising the associated image and the classified, associated text-readable document.

According to some aspects, in response to a selected object on a user interface, the received image is provided based on an initial interface provided to a user to provide the image by capturing a photo of a menu by using an image capture device instantiated by the user selecting the selected object, or by uploading a stored image.

According to other aspects, the performing the OCR operation comprises an OCR engine initially detecting all text in the received image, and recognizing the characters and the strings of characters that comprise the one or more words in the menu, and distinguishing each of the separate one or more words present in the image, so as to discern each of the characters, and correctly identify each of the characters.

According to still other aspects, the performing the skew detection comprises calculating a slope of bounding boxes associated with the detected texts, calculating a mode of the slopes of the bounding boxes and an angle of rotation associated with the slopes, and determining a presence of the skew for the bounding boxes having an angle of rotation at an angle of the image, based on the mode of the slopes not being equal to 0. The skew correction comprises initially augmenting dimensions of the image according to the angle of rotation, such that no information is cropped from the received image, rotating the received image by the angle of rotation, performing the OCR on the rotated received image, and obtain new coordinates for the bounding boxes of the text.

According to yet other aspects, the clustering comprises applying a geometric approach dependent on coordinates of the bounding boxes of each of the words, based on different x thresholds and y thresholds to determine which of the words should be associated, wherein the words that have coordinates which are close together in x and y axes are in the same line and are clustered together. For the y threshold, the words in the same line may overlap along the y-axis of the bounding boxes, and further comprising comparing the y-coordinates of one of the bounding boxes and an adjacent one of the bounding boxes, checking if a height of the bounding boxes for each of the words in the line is not within a prescribed percentage of each other to separate into plural clusters. The x threshold is dependent on a multiple of the median of an average length per character for the words.

According to additional aspects, the classifying comprises classifying each of the clusters is classified as one of price, menu item, menu description, or category, and the classifying as the price comprises taking a threshold on a ratio of a number of characters that are digits to a total number of characters in a cluster, and setting an upper limit on the total number of characters in the cluster, and further, wherein for the clusters that are not classified as the price, an operation is performed to dynamically determine distance thresholds between the clusters to that are not classified as the price to classify as a menu item or a menu description.

According to further aspects, the association comprises associating a cluster that is a menu item with respective next corresponding clusters that are menu description, price and category clusters, in an order of initial scanning by the OCR engine.

According to yet additional aspects, the automatically obtaining the image comprises automatically providing images associated with each digitized menu item based on an item name and an item description, wherein a dataset generated by curating digitized dish images, dish names and descriptions from multiple sources, generating a similarity index between each dish in the dataset and the digitized menu item, according to the dish name and description, by vectorizing each feature point and generating a vector similarity index.

Still further aspects of the present application may include a non-transitory computer readable medium executing the computer-readable instructions, to achieve functions and operations associated with the features disclosed in the detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Exemplary implementation(s) of the present invention will be described in detail based on the following figures, wherein:

FIG. 1 illustrates an example flow according to an example implementation.

FIG. 2 illustrates an example flow according to an example implementation.

FIGS. 3-10 illustrate example operations associated with skew detection and correction and menu generation according to an example implementation.

FIGS. 11-15 illustrate example user experiences associated with skew detection and correction and menu generation according to an example implementation.

FIGS. 16-23 illustrate example user experiences associated with menu generation according to the example implementation.

FIG. 24 illustrates an example environment according to an example implementation of the present application.

FIG. 25 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Aspects of the example implementations relate to systems, methods and processes associated with generation of a mart menu, such as for use in a restaurant menu, and more specifically, to performing skew detection and correction, as well as image selection. Accordingly, a user, such as a restaurant operator, owner, manager, or the like, may optionally provide input information, such as an existing menu. Alternatively, the user may select from one or more suggested menus provided by the system as a starting document. The result is a digitized menu that the user may provide to customers for use in a restaurant, such as for ordering items. While the present example implementation is directed to a restaurant environment, the inventive concept is not limited thereto, and other environments may be substituted therefor, as would be understood by those skilled in the art.

According to the example implementations, digitized (e.g., “smart”) menu recognition may be provided. Digitized menu recognition may accelerate the digitalization of a user's on-paper menus. Accordingly, the user may be provided with a quick way to upload its menus into an online format. For example, but not by way of limitation, instead of applying a related art approach of manually uploading paper menus into an online template, digitized menu recognition allows for the user to select an image (e.g., photo or picture), and for the automatic uploading of the information in their paper menu into an online format.

According to the example implementations here, digitized menu recognition may be a part of a vendor onboarding solution. More specifically, may provide an image (e.g., photo or sketch) of a menu. Thereafter, the system according to the example implementation may receive an image of the menu and immediately digitize the data, as well as recognize dish categories, dish names and respective descriptions and prices.

To accomplish the foregoing aspects of the example implementations, a clustering operation is initially performed, followed by a classification operation. For example, the text may be classified. While related art approaches may employ text classification approaches based on Deep Learning based optical character recognition (OCR) engines that the images are run through, the present example implementations perform clustering and classification by applying a geometric approach that is based on the coordinates of the detected text blocks in an image, to transfer the understanding associated with the physical image and its components, into an online format.

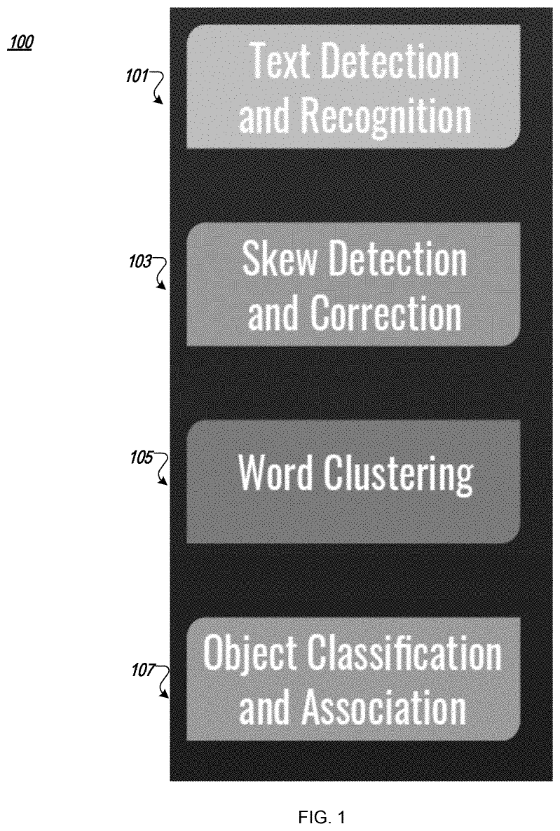

FIG. 1 illustrates a process 100 according to the example implementations. At 101, text detection and recognition are performed. For example, but not by way of limitation, one or more of the OCR engines may be employed. At 103, skew detection and correction may be performed. As disclosed herein, a geometric approach may be applied. At 105, word clustering is performed to develop the text associated with the menu. At 107, object classification and association are performed, including but not limited to the associated of an image with a menu item.

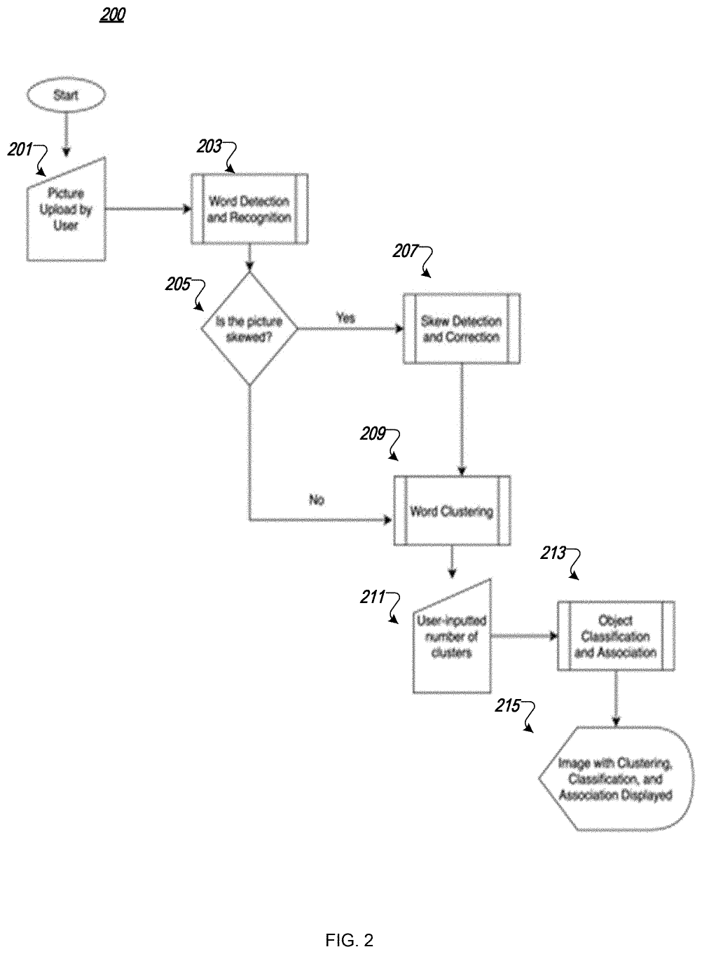

FIG. 2 illustrates a data flow diagram showing a process 200 according to an example implementation. At 201, an image is uploaded by a user. For example, but not by way of limitation, the image may be an existing menu. At 203, word recognition and detection is performed on the received image. For example, but not by way of limitation, the received image is processed by the OCR engine in the manner described herein. At 205, a determination is made as to whether the image is skewed.

If, as a result of the determination at 205, the image is determined to be skewed, then at 207, skew detection and skew correction is performed. For example, but not by way of limitation, the operations associated with detection and correction of the skew may be performed as disclosed below. If it is determined that the image is not skewed, then operation 207 is skipped.

After the foregoing operations 205-207, the output is provided with a correction of any skew. Then, at 209, word clustering is performed. At 211, the user provides a number of clusters to be determined, as explained in greater detail below. Once the clustering operation has been performed, at 213, object classification and association is performed. At 215, an image is obtained and provided for the menu, such that the clustering, classification and association are displayed.

As noted above, a geometric approach is employed instead of a deep learning-based approach. Accordingly, the general construction of a menu may be included in the process. With related art deep learning approaches, the performance may be heavily dependent on the dataset which is applied for training. Thus, the related art deep learning approach may not perform as well on an unknown dataset of menus, as is likely to be encountered in the digitized menu generation process. The geometric approach according to the example implementations may overcome this related art shortcoming. More specifically, the example implementations use properties of the general menu that are highly likely to be present in the target images that the geometric approach is applied to.

Thus, the example implementations may provide a complete automation of the digitization of a menu. For example, the contents of an uploaded menu image may be transferred in an efficient manner to an online, usable format. As a result, the speed at which restaurants may transfer into an online format may be substantially increased as compared with related art approaches. Further, the transfer to the online format may be performed with little to no additional user input. The parameters and required information for digitization of the menu is extracted from the image itself, and is automatically used to create the corresponding online template associated with the physical menu.

In a first process, such as 203 of FIG. 2, text detection and recognition may be performed. More specifically, a first stage of digitized menu recognition may initially detect all of the text in a menu and recognize the characters that make up each of the words in a menu. The text is detected by applying the process of the example implementations to distinguish each separate word that is present in the picture. Text recognition requires the ability to discern the separate characters that are included in the text, and to correctly identify each of those characters. To implement this stage of the example implementations, an OCR (Optical Character Recognition) engine can be used. For example, but not by way of limitation, an OCR engine that includes but is not limited to Tesseract, Amazon Textract, CuneiForm, and Google Cloud Vision may be employed to perform text detection and recognition.

Some OCR engines may have different performance characteristics with respect to the detection of text present in the images, such as failing to provide data on some or a substantial portion of the text present in an image. For example, some OCR engines may process entire blocks of texts as unrecognized, and have a lower low accuracy in transferring words into a digital format that other OCR engines, such that clustering and classification may have a corresponding low accuracy as well. Additionally, text recognition may be subpar for some OCR engines, as characters recognized incorrectly may lead to misspelled words, thus requiring additional parsing to generate the output. Further, performance for some OCR engines may be significantly lower for images that are not of high quality or were not scanned; some images may not have any recognized by the OCR engines, due to factors such as lighting, skew of the image, color, and background.

Other OCR engines may be more effective (e.g., Google Cloud Vision), due to superior performance in terms of detecting a higher percentage of text blocks present in images, and correctly detecting the characters present in a text block. The initial high level of performance may result in an improved ease of developing high accuracy clustering and classification algorithms, because of the preliminary scan having high accuracy.

Additionally, the Cloud Vision API as used in the example implementations may be more robust than other OCR engines and may be able to process a larger variety of images. Thus, the variation in the quality of incoming images allows for a greater range of image quality, including but not limited to shadows and/or different colors, while still maintaining high performance and accuracy levels. Moreover, the robustness removes the necessity for high quality or scanned images, and allows for results to be generalized to various image qualities. The Cloud Vision API as used in the present example implementations may use a pre-trained convolutional neural network (CNN) model to detect a bounding box around each word present in an image, and may return the coordinates of all four corners of the bounding box around each word that is recognized. These coordinates as received may be used throughout other aspects of the process associated with the algorithm, to perform clustering and/or classification.

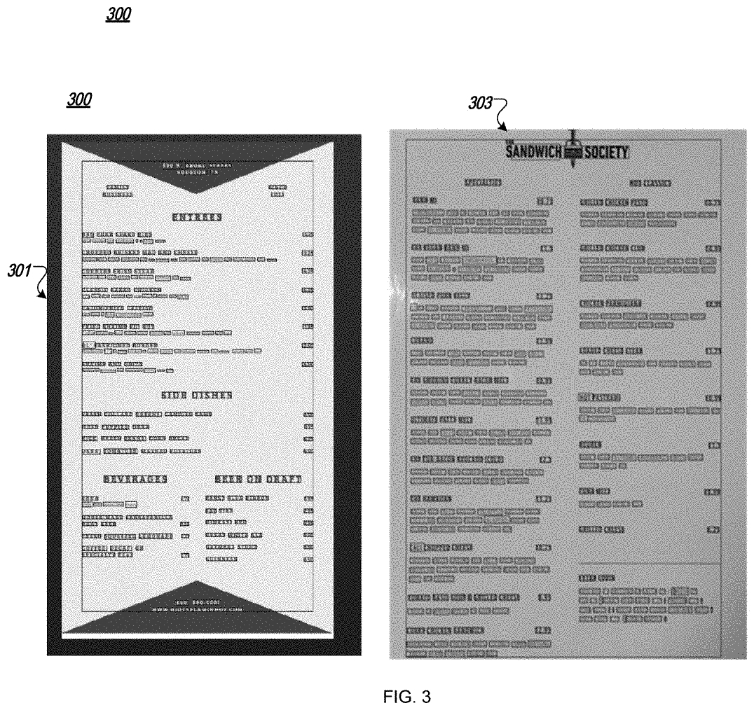

FIG. 3 illustrates examples 300 of the text that is detected by the OCR engine, along with the visualization of the bounding box associated with each of the words that are detected. As shown in the first and second examples 301, 303, the bounding boxes are drawn according to the coordinates that are outputted by the OCR engine.

According to some example implementations, an image that is uploaded by the user (e.g., vendor) may be rotated or skewed, such as determined at operation 205 of FIG. 2. In such cases, the image is preprocessed to change its orientation. More specifically, at 207 of FIG. 2, skew correction is performed to provide corrected upright coordinates for the bounding boxes of the words that are detected by the OCR engine. While the OCR engine may be able to detect and recognize text correctly regardless of the rotation of the image, the resulting rotation of the coordinates of the bounding box may prevent the example geometrically based algorithm from accurately performing the processing.

More specifically, the example implementations use as the input an upright, unrotated image. Accordingly, the example implementation requires detection and correction of skew. To detect skew, an operation is performed to calculate the slope of each of the bounding boxes for the text that is detected. Then, an operation is performed to calculate a mode of the slopes of the bounding boxes, as well as the angle of rotation associated with the slope, to determine the skew present in the image. For a skewed image, most of the bounding boxes would also be skewed at the angle of the image, which would cause the mode of the slopes to be nonzero. Thus, skew correction is only performed if the detected mode of the slopes is not 0.

Once the skew is detected, the example implementations perform skew correction at 207. More specifically, skew correction may be performed by initially augmenting dimensions of the image according to the angle of rotation, such that no information will be cropped from the original image during skew correction. Then, the image is rotated by the angle of rotation and is reprocessed by the OCR engine, to detect the rotated text again, and obtain new coordinates for the bounding boxes of the text. The skew detection and correction is critical for the aspects of the example implementations to provide the object classification and association.

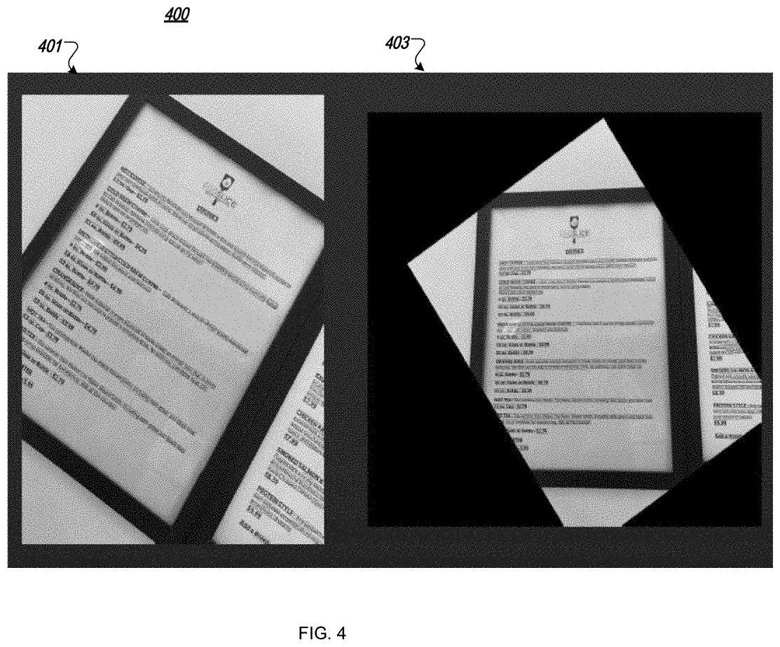

FIG. 4 illustrates images 400 associated with the example skew detection and correction. At 401, the original image of the menu and its associated bounding boxes are shown. As can be seen, all of the images and bounding boxes are skewed at an angle. At 403, the skew-corrected image of the menu and its associated upright bounding boxes are disclosed, employing the above-disclosed process.

As shown at 209 of FIG. 2, the example implementations also perform word clustering. For example, but not by way of limitation, the OCR engine may detect and recognize each word in an image separately, with different words having no level of correlation. The OCR engine also scans through the image (e.g., from left to right), and outputs the coordinates of each of the words that are detected. Thus, the structure of the image may be analyzed and used. To build in this correlation, word clustering is employed to determine which blocks of text are associated with each other, by way of their coordinates. For example, but not by way of limitation, clustering is employed to find and group the text that will compose a menu item, menu description, category, or price.

Since each of the words are initially considered separate, the example implementations provide an approach to group words together. To perform this clustering according to the example implementations, a geometric approach is used that is dependent on the coordinates of the bounding boxes of each separate word. The geometric approach depends on different x and y thresholds that are used to determine which words should be associated with each other. The initial assumptions made for clustering include an assumption that words that have coordinates which are close together in the x and y axes are in the same line, and that those words should be clustered together.

For the y threshold, words in the same line may have some level of overlap along the y-axis of their bounding boxes. Thus, a clustering operation is performed to cluster together words that have an overlap in the y-axis of their bounding boxes, by comparing the y-coordinates of a bounding box and the next bounding box as scanned by the OCR engine. To consider the case where two different clusters may be in the same line, such as a menu description being in the same line as a menu item, an additional condition is provided. More specifically, to take care of clustering of this sort, a checking operation is performed to check if the height of the bounding boxes for each word in a line are within a prescribed percentage (e.g., 30%) of each other. If this condition is not met, the clusters are split.

Further, to avoid clustering together words that are too far apart but in the same line, an x threshold is et that is dependent on a multiple (e.g., 3 times) the median of the average length per character for all words. Examples of words that are not intended to be clustered together but may be in the same line are, for example, two separate menu items that are positioned in two adjacent columns. Accordingly, the x threshold value was set to take into account the foregoing condition. Since the whitespace between two words is approximately the length of a character in an arbitrary word, an average length per character metric is used to give bounds to the threshold.

For example, but not by way of limitation, the average length per character metric was calculated by dividing the horizontal length of the bounding box for a word by the number of characters in that word. A factor of the median of these values was used, to take into account the possibility of different fonts affecting the median or mode. For example, in the case where the font of the description is smaller than the font of a menu item where the number of words in the description is also much larger than the number of words in menu items, it may be likely that the median or mode will be skewed towards the values from the length per character of the description. Thus, to generalize the thresholding operation of the example implementation to a wider variety of menus, the threshold may optionally be assigned a less strict boundary, by choosing a multiple of the median value.

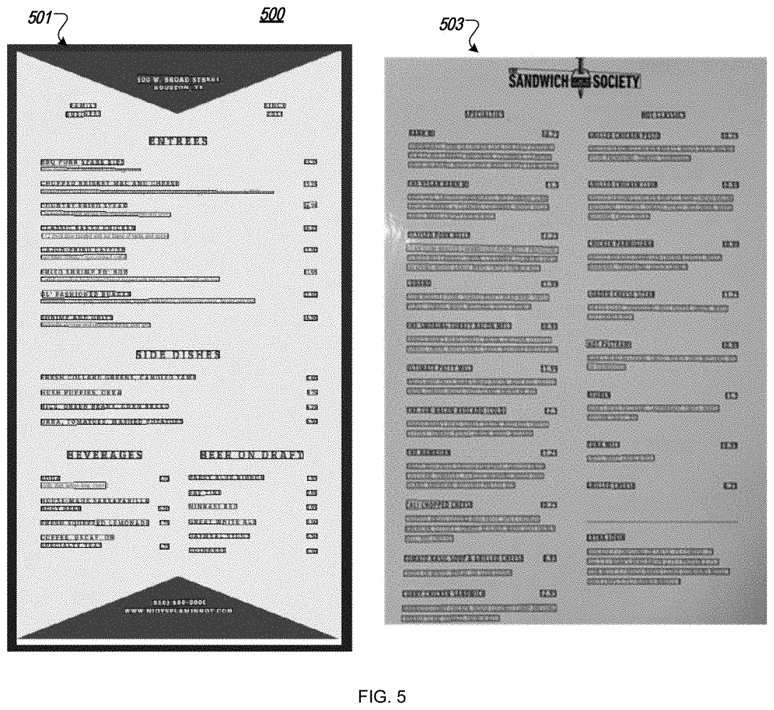

FIG. 5 illustrates examples 500 associated with clustering. More specifically, the examples, 501, 503, illustrate clustering according to the example implementations. The black boxes that are drawn are each associated with a separate cluster, which will subsequently be classified. The larger cluster bounding boxes are drawn according to the coordinates output by the OCR engine.

After clustering has been completed, at 213 of FIG. 2, classification is performed according to the example implementations. More specifically, each of the clusters is classified, as one of: price, menu item, menu description, or category. While the foregoing classes are provided, other classes may be added or substituted, as would be understood by those skilled in the art.

The example implementations may perform classifying of the clusters as price, by taking a threshold on the ratio of the number of characters that are digits, to the total number of characters in a cluster, as well as setting an upper limit on the number of characters present in a cluster. Thus, if a cluster satisfies more than half its characters being digits, as well as having a total character count of less than 10 characters, the cluster is classified as a price. In the present example implementation, the ratio and total character limits were set to avoid classifying menu descriptions or menu items that include as the price. The price classification algorithm according to the example implementations executes through every cluster in an image, and only classifies clusters which meet the requirements as “Price”. All clusters that do not meet the requirements as not classified (e.g., leaving everything else classified as “None”).

After performing the price classification as described above, an operation is performed to dynamically determine distance thresholds between different clusters. The example implementations receive user input for the number of clusters present in a menu image, and determine the corresponding number of thresholds using K-Means. For example, but not by way of limitation, a menu with only menu items and no menu descriptions would only have 2 distances d1 and d2 between clusters: a distance d1 between a category and a menu item, and a distance d2 between a menu item and the next menu item. Additionally, if the menu had menu descriptions, an additional distance d3 between a menu item and its corresponding menu description would be added, and the distance between a menu item and the next menu item would be replaced by the distance between a menu description and the next menu item.

The value for the number of clusters present in the menu image may vary in accordance with the complexity of the menu. For example, but not by way of limitation, for more complicated menus with variations and additional optional items or modifiers associated with the menu item such as toppings for pizza such as additional vegetables, a number of clusters may be increased and may lead to additional distances to be dynamically calculated, to then classify the additional clusters. The approach according to the example implementations is not limited to the forgoing, and may be extended to correctly classify more complex images using the geometric approach disclosed herein, which is dependent on the dynamically calculated distance thresholds.

The distances between clusters may be computed as a line height, defined to be the vertical distance between the bottom left corner of the top cluster, and top left corner of the bottom cluster. The classification operation is performed on all pairs of clusters, and the minimum line height is determined for each cluster. To perform K-Means clustering, the minimum line height computed for each cluster is used, corresponding to the minimum vertical distance between a cluster and any of the clusters below it. A K-Means operation is executed to determine the grouping of the minimum line heights. A user-input value is provided for the number of clusters that the K-Means algorithm detects, where the centroid values correspond to the distance thresholds d1, d2, . . . , d_n, depending on the number of clusters present in the image.

While the present example implementations are directed to K-Means, multiple different clustering algorithms may be used to dynamically determine the distances between the different clusters after the minimum line height distances were computed. For example, but not by way of limitation, DBSCAN, which is a density-based clustering algorithm, may be used on the same minimum line height distance array to try to determine the number of clusters along with the distance thresholds without any user input. However, the other clustering algorithms do not provide the performance level of K-Means with a user-defined amount of clusters. Further, Agglomerative or Hierarchical Clustering may be used.

Once the distance thresholds are determined by K-Means clustering, the classification of each of the clusters not already classified as price is performed. Analogous to the foregoing execution of the price classification, the classification of a cluster as a category not dependent on the dynamic distance thresholds, was performed. Category classification was executed using a threshold that set using a factor of a multiple (e.g., 1.5 times) the median box height of all the clusters, where the box height is defined as the vertical distance between the top and bottom left corner of the bounding box for a cluster. The foregoing threshold was applied based on the assumption that the font of a category is substantially larger than the font of other words in the image. Accordingly, box height was used as a proxy for the font size, as other approaches do not provide an accurate number for font size. For example, calculating a font size by using the average area taken up by a character in the bounding box is too variable and is dependent on the specific characters in the word, which may lead to a lack of robustness.

Classification of the rest of the unclassified clusters as either a menu item or menu description was then executed. For example, the process included recalculation of minimum cluster line heights, not including measurements with clusters already classified as price, or clusters that had a horizontal distance of more than a multiple (e.g., 0.4 times) the width of the entire image between the top left corners of their respective cluster bounding boxes. No cluster heights were calculated between any pair of clusters that had a cluster identified as price, because the price that corresponds to a menu item may be in-line with a menu item, which would cause the minimum cluster height to be smaller than the actual cluster height. The second condition, imposing the horizontal distance between two clusters, was chosen to correctly perform classification on menus with multiple columns. If there are multiple columns in an image, two different menu items will be in-line, leading to the above-described issue with respect to the price condition. To avoid the foregoing issue, a boundary was set such that two clusters must be less than a multiple (e.g., 0.4 times) the width of the image in horizontal distance from each other to have a cluster line height distance be computed for the pair.

After calculation of the minimum cluster line heights, classification was performed using the dynamically calculated distance thresholds as boundary values as well as the user-inputted value for the number of clusters, which is used to determine whether there are menu descriptions in the menu. The distance between a menu item and a corresponding menu description are less than the distance between a menu description and the next menu item. Using this information on the distance thresholds and minimum cluster height, classification is performed for the bottom cluster of a pair of clusters, as either menu item or menu description. Thus, classification of clusters in an image is completed.

Following classification, an association operation is performed, as also shown in 213 of FIG. 2. For example, but not by way of limitation, clusters may be associated with each other, specifically a menu item with its corresponding menu description, price, and category. This association operation is performed after classification, to operationalize the order of initial scanning done by the OCR engine, such as from left to right and top to down, along with the assumption that both menu description and price will be positioned after a menu item in the order scanned, for association purposes. Thus, association is performed for each cluster that has been classified as a menu item with the next menu description and next price clusters that are encountered while going through the image.

After association is performed for a menu item to its menu description and price, association is performed with respect to a category. This association is determined by iterating through the categories that are vertically above the menu item and finding the category that is closest vertically and also in the same column. For one-column menus, the approach of associating menu items with the nearest category above it may be employed. For a multi-column menu, column boundaries must be defined. In a manner analogous to the above-disclosed clustering in multi-column menus, a horizontal threshold may be employed that is dependent on the width of the image itself, on top of the vertical threshold where the category is above the menu item, to determine which category should be associated with a menu item. This example implementation provides for various menus where a category in different categories (e.g., overlapping categories) are not in the same horizontal line, as well as menus where multiple categories exist in different columns, allowing for additional generalizability.

The association allows menu item names to be used as queries, to find its associated menu description and price. Storing associated clusters may provide additional insight into the overall structure of the menu, and may increase the ease of access, for both vendors and end users to access data about the menu items.

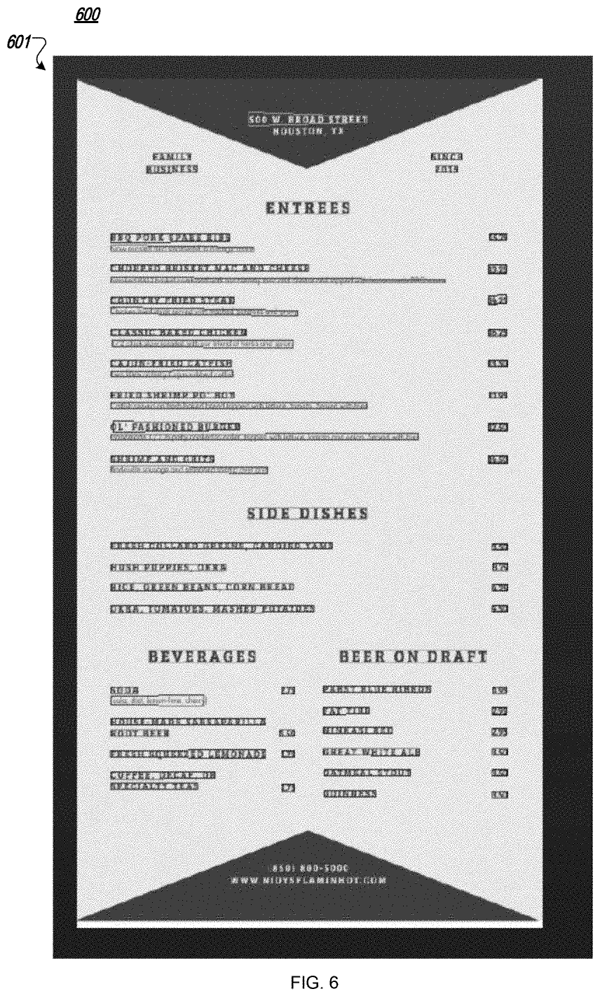

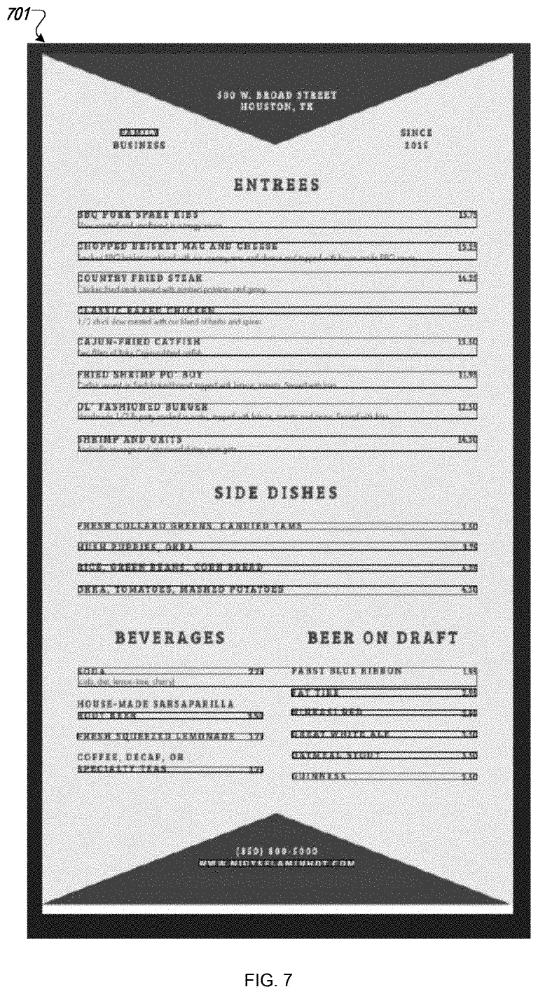

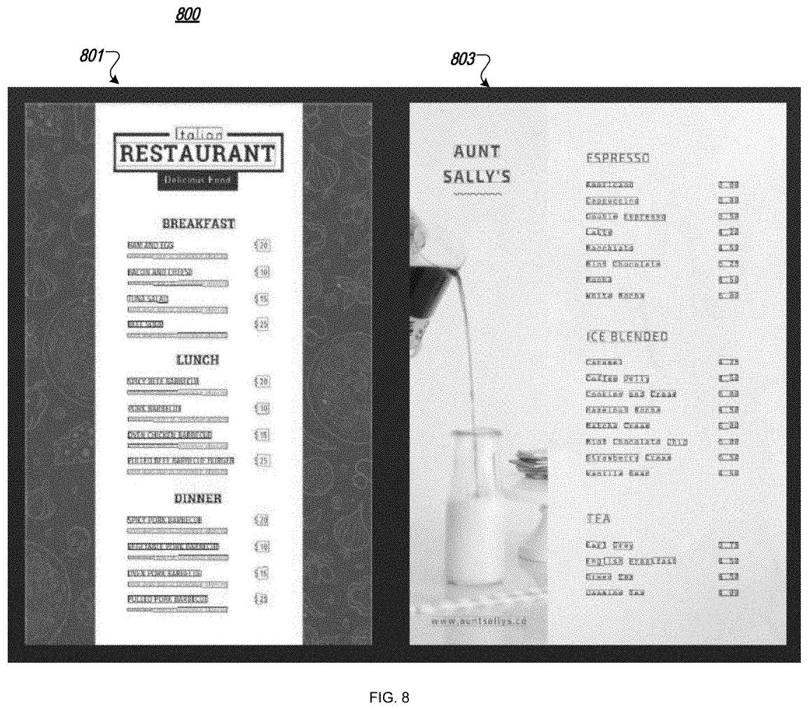

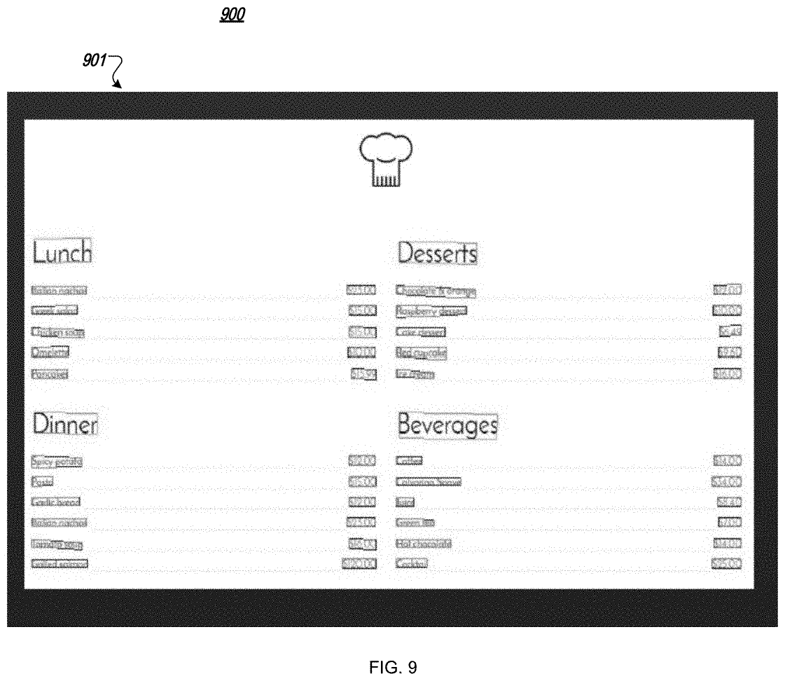

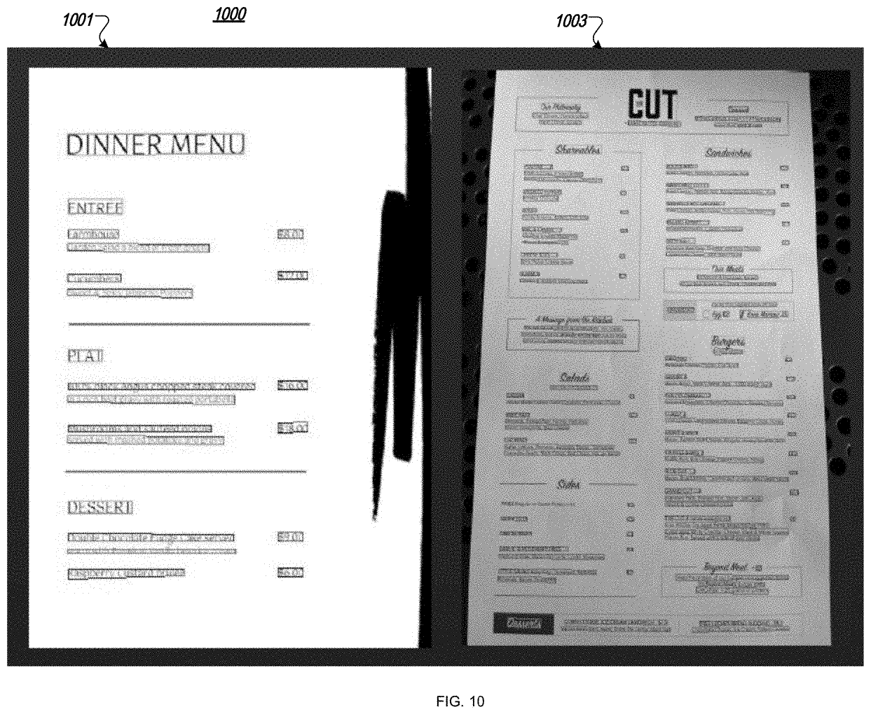

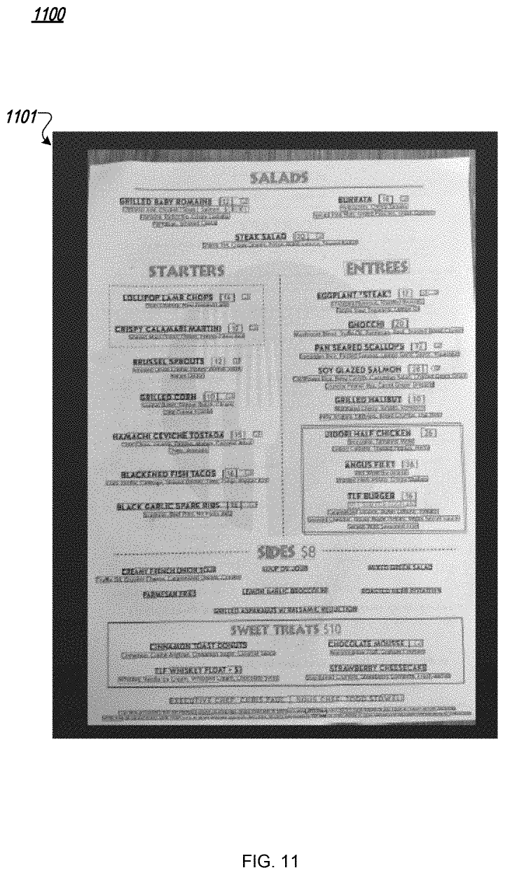

FIGS. 6-11 illustrate other examples 600-1100 of execution of the example implementations on sample images 601, 701, 801, 803, 901, 1001, 1003, 1101 with the final classification results shown. In each of these images, purple corresponds to a menu item, red corresponds to a menu description, green corresponds to a category, and blue corresponds to a price.

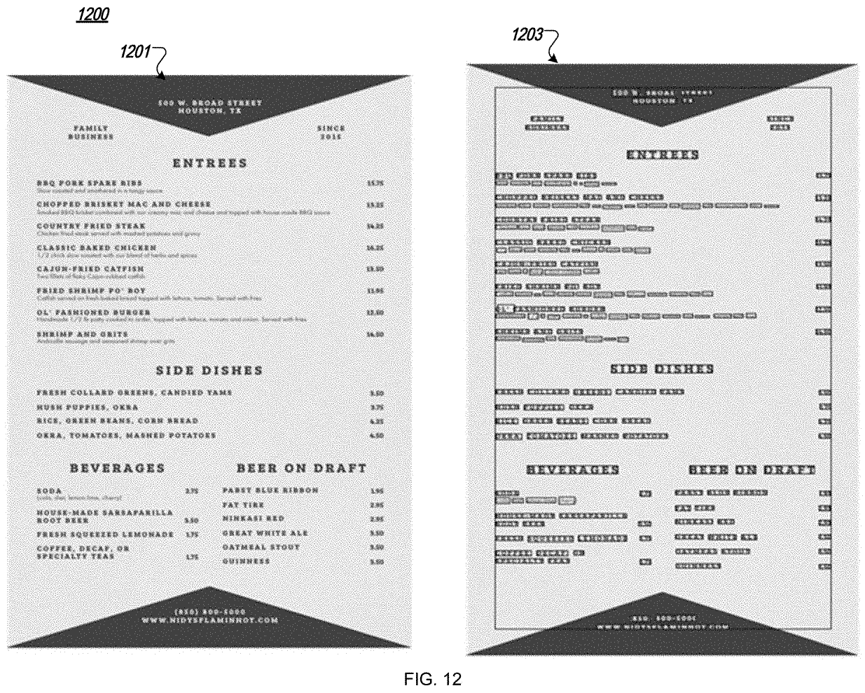

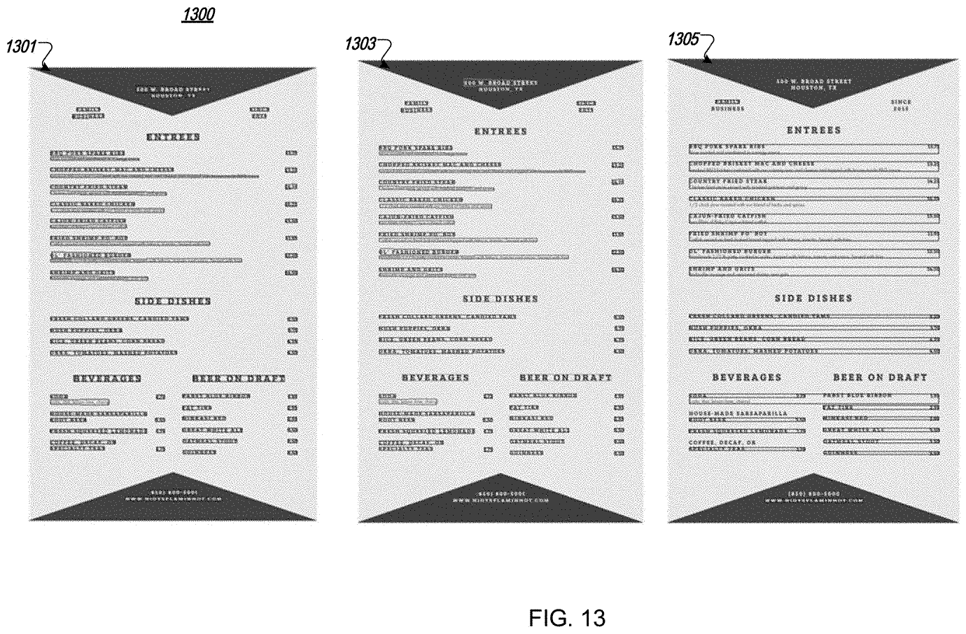

FIGS. 12-13 illustrate a step-by-step version of example implementation, running on a sample image where in the penultimate image, purple corresponds to a menu item, red corresponds to a menu description, green corresponds to a category and blue corresponds to a price.

At 215 of FIG. 2, the example implementations further include an aspect to update the current digitized menu to optionally provide additional appeal and information presentation, by automatically providing images associated with each choice (e.g., dish) in the menu based on its name and description.

This menu generation module is based on a very large dataset generating by curating dish images, dish names and descriptions from multiple sources such as but not limited to well-known sources such as wikipedia, AIFood (A large scale food image dataset for ingredient recognition), food101 dataset, food image dataset, Recipe1M+(a new large-scale, structured corpus of over one million cooking recipes and 13 million food images) and Food-11. The curated data includes dishes of various cuisines and categories.

Once the dish information has been digitized and associated using the previously mentioned operations of the example implementations, a similarity index is calculated between each dish in the image dataset and the digitized menu item, according to the dish name and description using “bag of words” similarity approach. For example, but not by way of limitation, the similarity index may be further fine-tuned by vectorizing each feature point and generating a vector similarity index as well.

An image of the data point with the highest similarity index is assigned to the particular menu item. Further, images from the best-fit (e.g., top 10) data points according to their similarity index is recommended to the user as an option for image replacement.

For the situation where the digitized menu items lack menu descriptions, the menu generation module may apply only dish names as feature vector, and automatically import the dish description from the data point with the highest similarity index. Thus, the menu generation module may generate an appealing digital menu, and may significantly reduce the vendor's manual tasks for onboarding the menu by automatically selecting the best-fit image for each item, recommending alternatives for the vendor to choose, and auto-completing any missing menu item details.

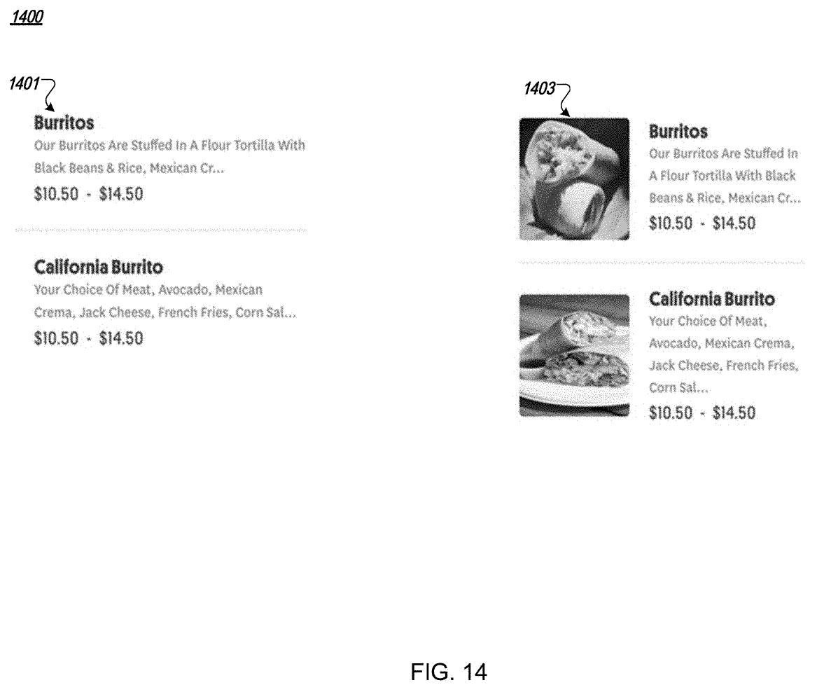

FIG. 14 illustrates menus 1400 associated with the example implementation. At 1401, an original menu item is shown, and at 1403, a menu item processed by the menu generation module is shown. More specifically, the original digitized menu includes menu names and descriptions for menu times. The menu generation module generated a similarity score using name and description with respect to every data point in the dataset, to find the most similar data point. The image of the most similar data points was selected as the image for dish menu items, as shown in 1403. Specific dishes with nuanced variations may require item names, and descriptions for effective image recommendation.

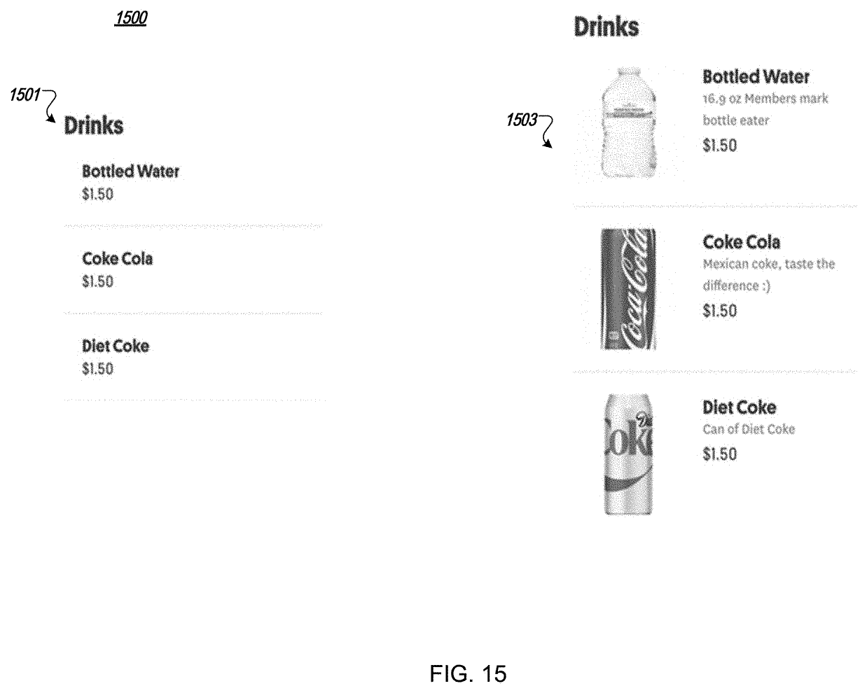

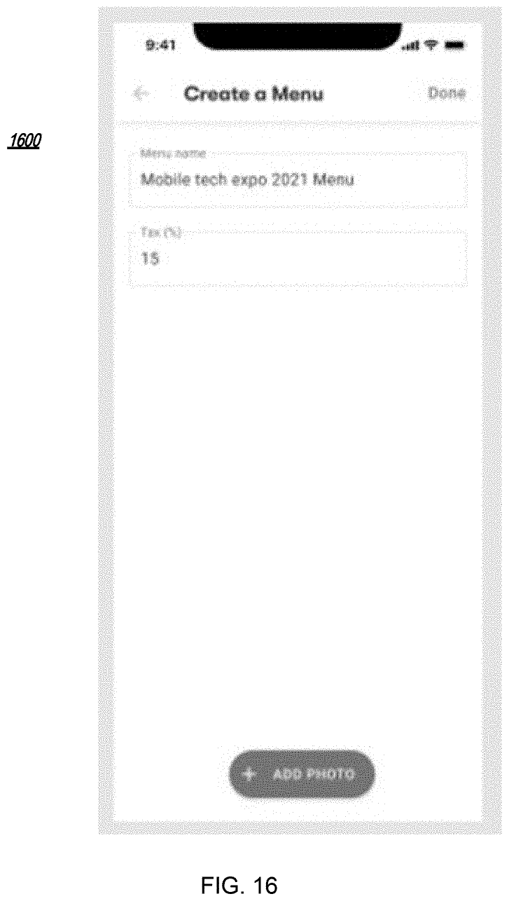

FIG. 15 illustrates menus 1500 associated with the example implementation. At 1501, an original digitized image of the menu is shown, and at 1503, a menu as processed by the menu generation module is shown. At 1501, the description of the menu items is not available. Thus, only uses menu item names are used to generate the similarity score with respect to all data points, and the image is imported, as well as descriptions of the most similar data points found. The item name only approach may be effective in case of general items such as drinks, deserts and branded products, which require less data to identify the features for similarity estimation.

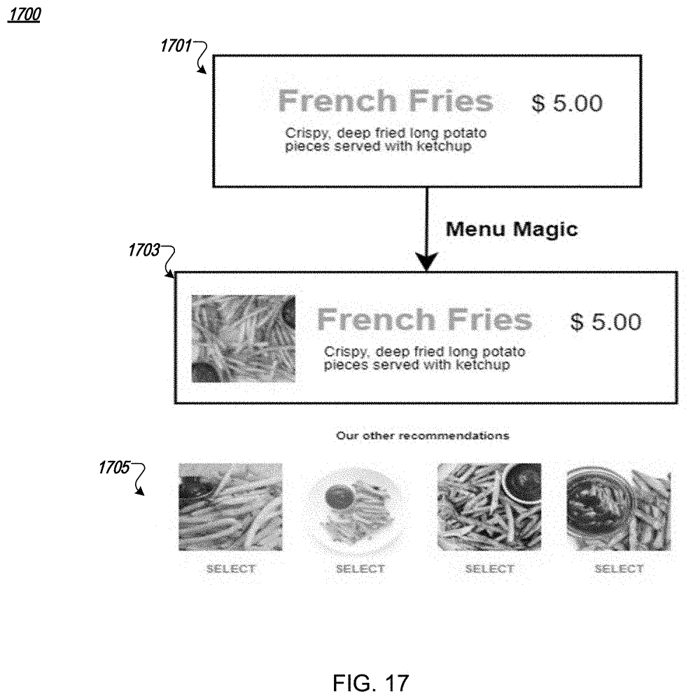

FIG. 17 illustrates and example schematic implementation of the menu generation module at 1700. More specifically, as shown in 1701, the initial uploaded menu includes the item name, item description and price. At 1703, the menu generation module applies the approaches disclosed herein to select an image for placement with the menu item. Additionally, at 1705, the menu generation module provides additional candidate images, which the user may select to include with the item, instead of the image provided in 1703.

The foregoing operations of the example implementations may be integrated to provide for a smooth and quick onboarding process, using only menu images.

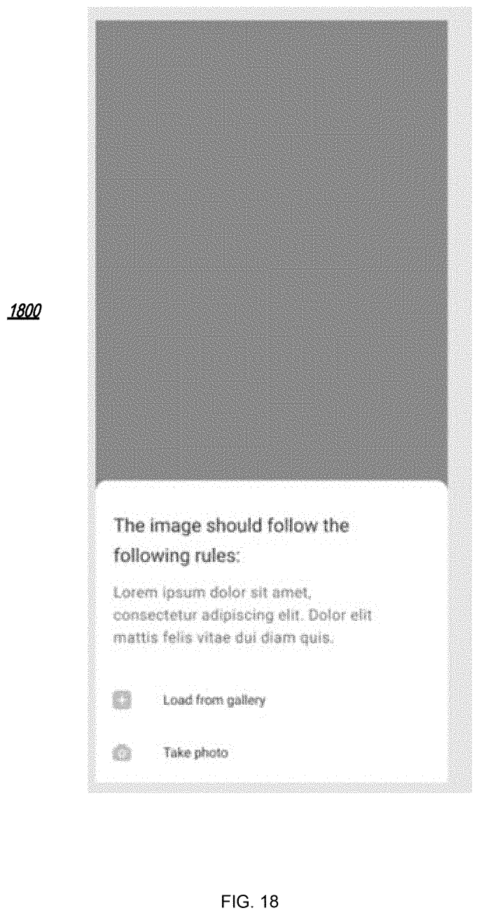

FIGS. 17-23 illustrate various aspects of the user experience according to the example implementations. As shown in FIG. 17, an initial interface 1700 is provided to the user for menu creation. For example, but not by way of limitation, the user may create a menu name, and enter information associated with the menu generation (e.g., taxation rate for the restaurant). The user may also provide an image, such as by capturing a photo of a menu by camera or the like. The image may be uploaded, either directly from the camera or from memory prior to the upload. An object, such as a floating button, may be provided on the user interface, so that the user may directly access the camera to capture the image, or access a memory to upload a pre-stored photo of the menu. For example, but not by way of limitation, this option 1800 is illustrated in FIG. 18.

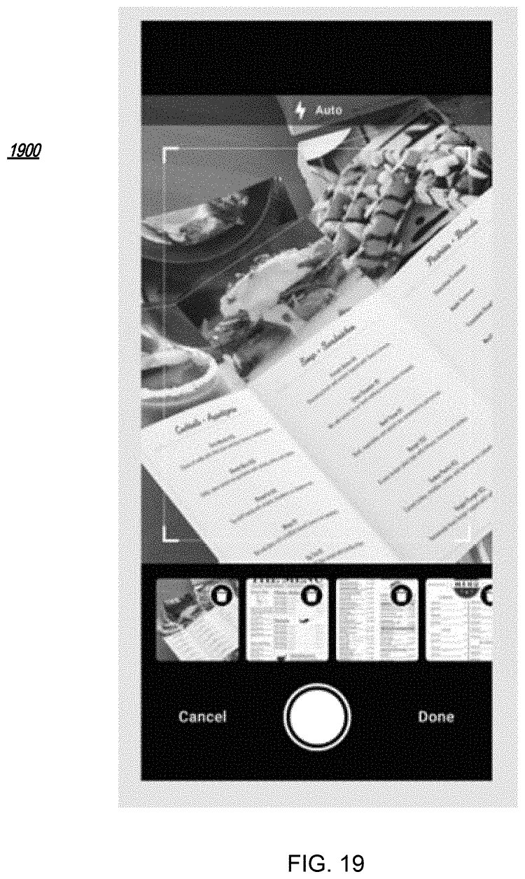

As shown in FIG. 19 at 1900, if the user decides to directly capture the photo, the camera application associated with the mobile device is opened. As can been seen, a bounding box is provided for the user to align the borders of the photo with the menu borders, before capturing the image. For example, the bounding box may guide the user to take an upright photo that reduces or substantially eliminates the skew based on the angle of the camera with respect to the menu. Further, the upright photo may also increase accuracy of menu recognition.

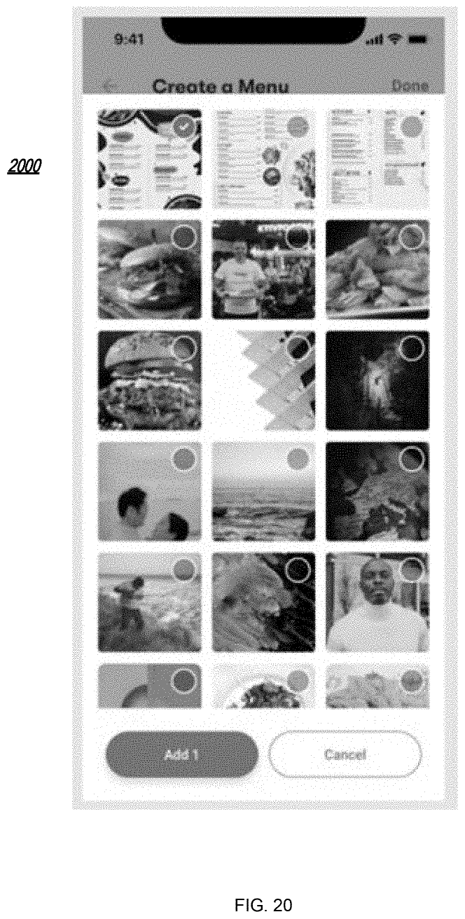

Alternatively, as shown in FIG. 20, if the user decides to upload an existing image instead of capturing a new image by camera, the user is provided with an interface 2000, by which to upload one or more image

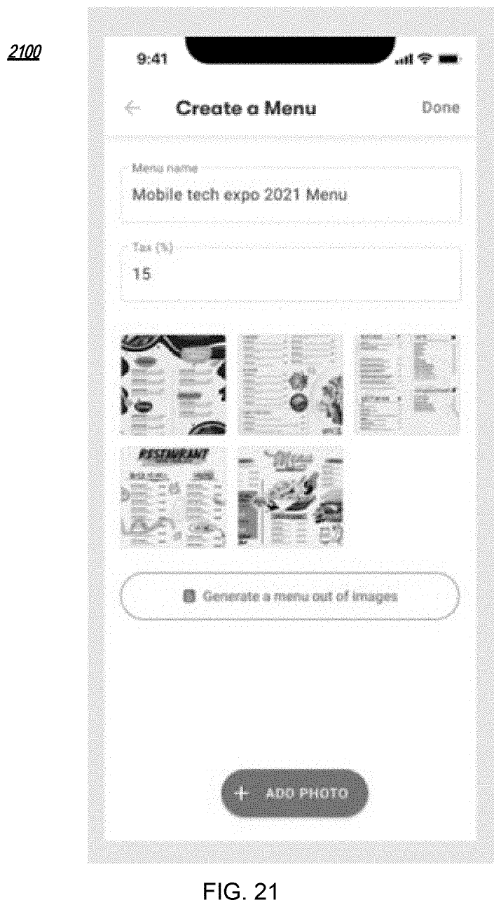

As shown in FIG. 21, after either FIG. 19 or FIG. 20 is accessed by the user to obtain the image of the menu, the user, is provided with a user interface 2100 to create a menu. More specifically, the user may view the menu name, initially entered information such as tax details, or other information, and also upload one or more photos. Once the user has selected the one or more photos, the option of generating a menu from the images may be selected. From that point, the user may be able to access a subsequent screen, to select the image and to start the generation of the menu.

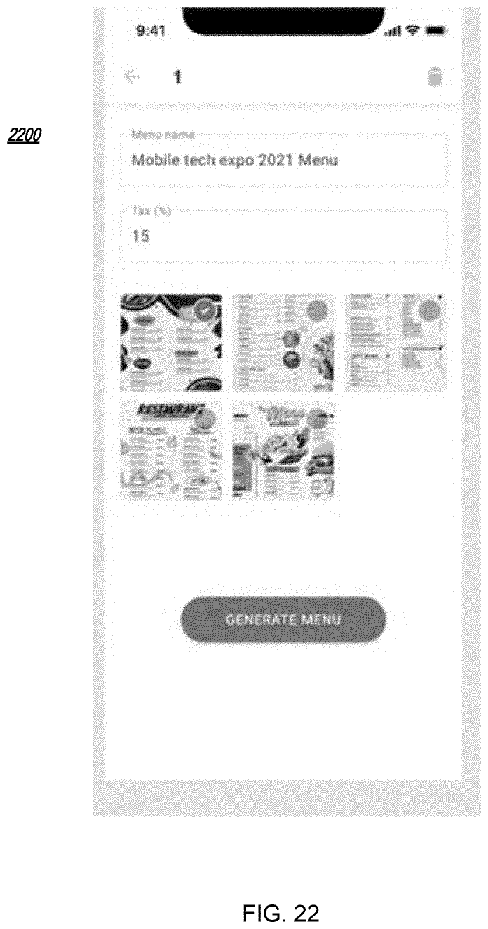

As shown in FIG. 22, once the user has selected the image(s), the user selects the “generate” option at 2200. At this point, operations 203-213 of FIG. 2 are performed to automatically generate the digital menu.

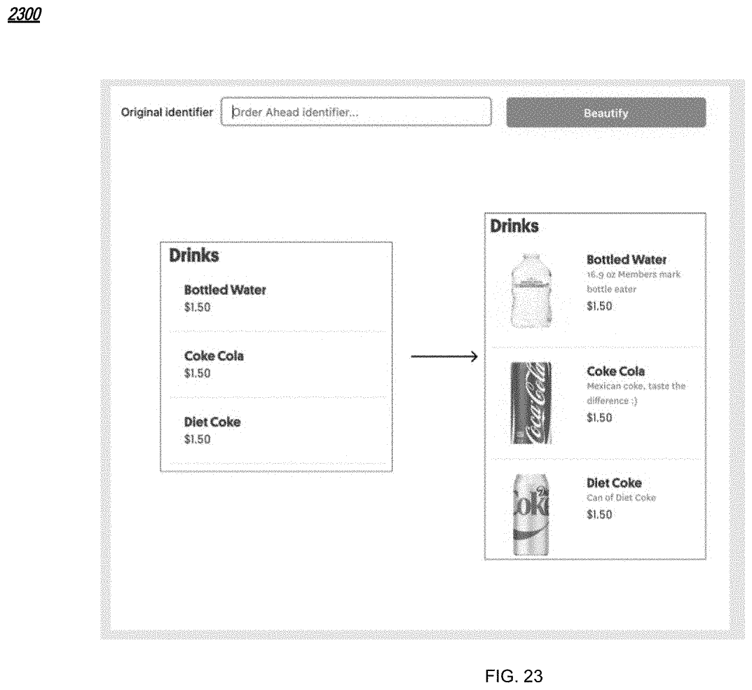

As shown in FIG. 23, the output of the process is shown on a review screen 2300. The user may see the original menu from the captured image on the left, as compared with the generated menu from the operations of the example implementations on the right. Further, to add the images associated with the menu items, the user may select an object such as the “Beautify” button to perform operation 215 of FIG. 2. Accordingly, the result is shown on the right side with the added images.

Example Environment

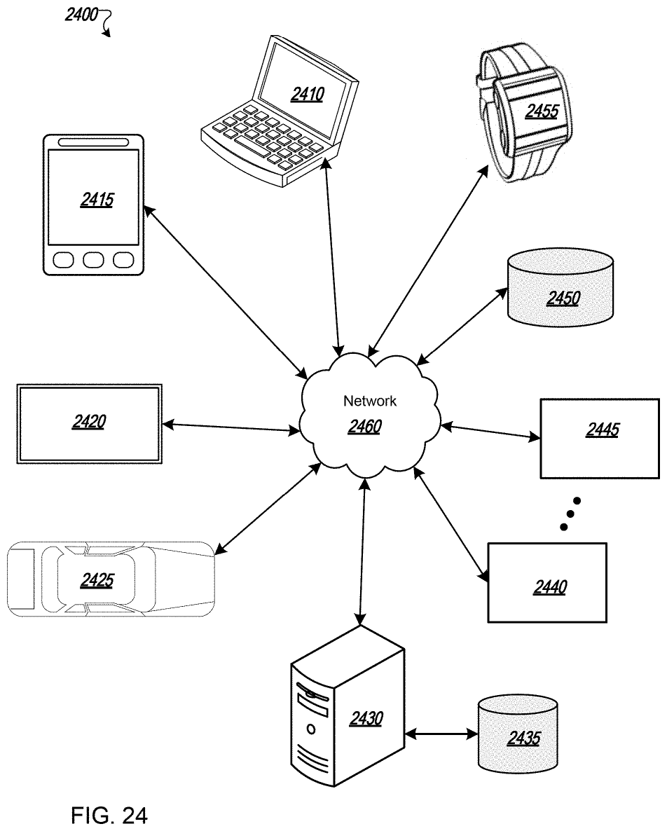

FIG. 24 shows an example environment suitable for some example implementations. Environment 2400 includes devices 2410-2455, and each is communicatively connected to at least one other device via, for example, network 2460 (e.g., by wired and/or wireless connections). Some devices may be communicatively connected to one or more storage devices 2440 and 2445.

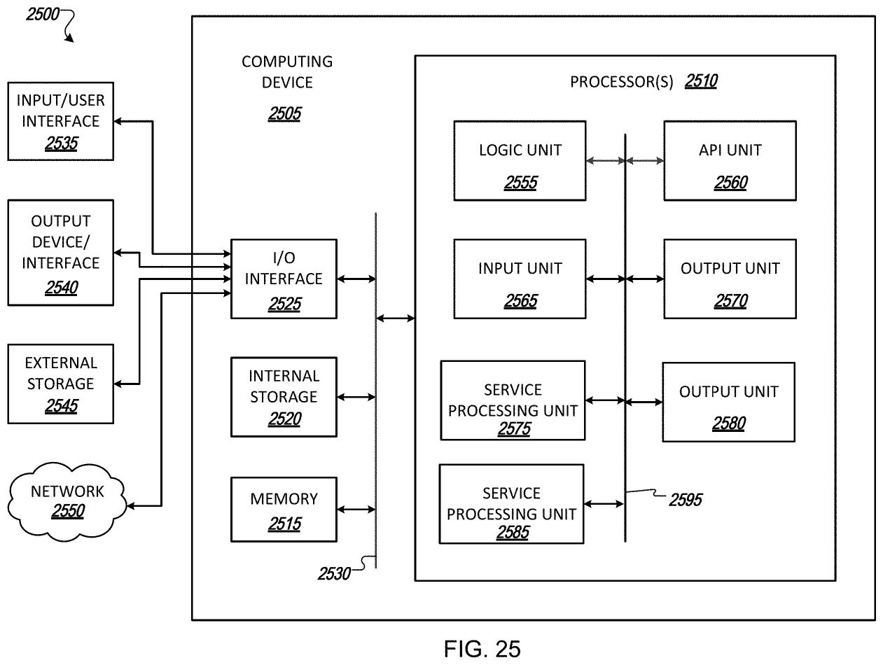

An example of one or more devices 2410-2455 may be computing devices 2500 described in FIG. 25, respectively. Devices 2405-2455 may include, but are not limited to, a computer 2410 (e.g., a laptop computing device) having a monitor, a mobile device 2415 (e.g., smartphone or tablet), a television 2420, a device associated with a vehicle 2425, a server computer 2430, computing devices 2435 and 2450, storage devices 2440 and 2445, and smart watch or other smart device 2455.

In some implementations, devices 2410-2425 and 2455 may be considered user devices associated with the users of the enterprise. Devices 2430-2450 may be devices associated with service providers (e.g., used by the external host to provide services as described above and with respect to the collecting and storing data).

The above-disclosed hardware implementations may be used in the environment of FIG. 24, as would be understood by those skilled in the art. For example, but not by way of limitation, and as explained above, some of the Wi-Fi enabled devices will be mobile, such as a smart phone 2415 or a wearable 2455. On the other hand, some devices may not be mobile, or may be intended to be excluded based on their device type, such as a desktop computer 2430 or a laptop 2410. Further, the cloud server (e.g., computing device 2450) explained above may be accessed via the network 2460.

Further, some of the venues may be mobile. For example, a mobile structure such as a food truck which has a queuing system, and may have a relevant perimeter, such as park, parking lot, or roped off area around the food truck, may be provided. This may be represented as element 2425, for example.

Example Computing Environment

FIG. 25 shows an example computing environment with an example computing device suitable for implementing at least one example embodiment. Computing device 2505 in computing environment 2500 can include one or more processing units, cores, or processors 2510, memory 2515 (e.g., RAM, ROM, and/or the like), internal storage 2520 (e.g., magnetic, optical, solid state storage, and/or organic), and I/O interface 2525, all of which can be coupled on a communication mechanism or bus 2530 for communicating information. Processors 2510 can be general purpose processors (CPUs) and/or special purpose processors (e.g., digital signal processors (DSPs), graphics processing units (GPUs), and others).

In some example embodiments, computing environment 2500 may include one or more devices used as analog-to-digital converters, digital-to-analog converters, and/or radio frequency handlers.

Computing device 2505 can be communicatively coupled to input/user interface 2535 and output device/interface 2540. Either one or both of input/user interface 2535 and output device/interface 2540 can be wired or wireless interface and can be detachable. Input/user interface 2535 may include any device, component, sensor, or interface, physical or virtual, which can be used to provide input (e.g., keyboard, a pointing/cursor control, microphone, camera, Braille, motion sensor, optical reader, and/or the like). Output device/interface 2540 may include a display, monitor, printer, speaker, Braille, or the like. In some example embodiments, input/user interface 2535 and output device/interface 2540 can be embedded with or physically coupled to computing device 2505 (e.g., a mobile computing device with buttons or touch-screen input/user interface and an output or printing display, or a television).

Computing device 2505 can be communicatively coupled to external storage 2545 and network 2550 for communicating with any number of networked components, devices, and systems, including one or more computing devices of the same or different configuration. Computing device 2505 or any connected computing device can be functioning as, providing services of, or referred to as a server, client, thin server, general machine, special-purpose machine, or another label.

I/O interface 2525 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2500. Network 2550 can be any network or combination of networks (e.g., the Internet, local area network, wide area network, a telephonic network, a cellular network, satellite network, and the like).

Computing device 2505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 2505 can be used to implement techniques, methods, applications, processes, or computer-executable instructions to implement at least one embodiment (e.g., a described embodiment). Computer-executable instructions can be retrieved from transitory media, and stored on and retrieved from non-transitory media. The executable instructions can be originated from one or more of any programming, scripting, and machine languages (e.g., C, C++, C#, Java, Visual Basic, Python, Perl, JavaScript, and others).

Processor(s) 2510 can execute under any operating system (OS) (not shown), in a native or virtual environment. To implement a described embodiment, one or more applications can be deployed that include logic unit 2555, application programming interface (API) unit 2560, input unit 2565, output units 2570 and 2580, service processing units 2575, 2585, and inter-unit communication mechanism 2595 for the different units to communicate with each other, with the OS, and with other applications (not shown).

For example, first service processing unit 2575 may perform the operations 100 associated with the text detection and recognition, skew detection and correction, word clustering, object classification and associate, and provide an output by the first output unit 2570. Second service processing unit 2585 may perform the operations associated with the menu generation module and provide an output by the second output unit 2580, The described units and elements can be varied in design, function, configuration, or implementation and are not limited to the descriptions provided.

In some example embodiments, when information or an execution instruction is received by API unit 2560, it may be communicated to one or more other units (e.g., logic unit 2555, input unit 2565, output units 2570 and 2580, service processing units 2575 and 2585). For example, input unit 2565 may use API unit 2560 to connect with other data sources so that the service processing units 2575 and 2585 can process the information.

In some examples, logic unit 2560 may be configured to control the information flow among the units and direct the services provided by API unit 2560, input unit 2565, output units 2570 and 2580, and service processing units 2575 and 2585 in order to implement an embodiment described above.

The example implementations described herein may have various benefits and advantages. For example, but not by way of limitation, menu details and information may be transferred into an online format. As a result, the user may be able to better access a large online market, beyond the scope of that which is reachable having a localized (e.g., paper) menu. Further, by using an automatic digitization solution, barriers to entry in an online market may be avoided or eliminated. For example, but not by way of limitation, the potential disadvantage of a user having a lack of web development skills may be mitigated. Further, the user may experience an improvement in speed and ease of access.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method for automatically generating a digitized menu, the computer-implemented method comprising:
receiving an image associated with a non-digitized menu;
performing an optical character recognition (OCR) operation on the received image, to identify characters and strings of characters comprising one or more words, to generate a text-readable document;
determining whether the received image is skewed to generate a determination;
for the determination providing an indication that the received image is skewed, performing skew detection and skew correction;
clustering the identified characters and strings of characters to generate a clustered text-readable document;
classifying the clusters, and associating the classified clusters to generate a classified, associated text-readable document;
for one or more items on the classified, associated text-readable document, automatically obtaining an associated image; and
providing the digitized menu comprising the associated image and the classified, associated text-readable document.

2. The computer-implemented method of claim 1, wherein in response to a selected object on a user interface, the received image is provided based on an initial interface provided to a user to provide the image by capturing a photo of a menu by using an image capture device instantiated by the user selecting the selected object, or by uploading a stored image.

3. The computer-implemented method of claim 1, wherein the performing the OCR operation comprises an OCR engine initially detecting all text in the received image, and recognizing the characters and the strings of characters that comprise the one or more words in the menu, and distinguishing each of the separate one or more words present in the image, so as to discern each of the characters, and correctly identify each of the characters.

4. The computer-implemented method of claim 1, wherein the performing the skew detection comprises calculating a slope of bounding boxes associated with the detected texts, calculating a mode of the slopes of the bounding boxes and an angle of rotation associated with the slopes, and determining a presence of the skew for the bounding boxes having an angle of rotation at an angle of the image, based on the mode of the slopes not being equal to 0.

5. The computer-implemented method of claim 4, wherein the skew correction comprises initially augmenting dimensions of the image according to the angle of rotation, such that no information is cropped from the received image, rotating the received image by the angle of rotation, performing the OCR on the rotated received image, and obtain new coordinates for the bounding boxes of the text.

6. The computer-implemented method of claim 1, wherein the clustering comprises applying a geometric approach dependent on coordinates of the bounding boxes of each of the words, based on different x thresholds and y thresholds to determine which of the words should be associated, wherein the words that have coordinates which are close together in x and y axes are in the same line and are clustered together.

7. The computer-implemented method of claim 6, wherein for the y threshold, the words in the same line may overlap along the y-axis of the bounding boxes, and further comprising comparing the y-coordinates of one of the bounding boxes and an adjacent one of the bounding boxes, checking if a height of the bounding boxes for each of the words in the line is not within a prescribed percentage of each other to separate into plural clusters.

8. The computer-implemented method of claim 7, wherein the x threshold is dependent on a multiple of the median of an average length per character for the words.

9. The computer-implemented method of claim 1, wherein the classifying comprises classifying each of the clusters is classified as one of price, menu item, menu description, or category, and the classifying as the price comprises taking a threshold on a ratio of a number of characters that are digits to a total number of characters in a cluster, and setting an upper limit on the total number of characters in the cluster, and further, wherein for the clusters that are not classified as the price, an operation is performed to dynamically determine distance thresholds between the clusters to that are not classified as the price to classify as a menu item or a menu description.

10. The computer-implemented method of claim 1, wherein the association comprises associating a cluster that is a menu item with respective next corresponding clusters that are menu description, price and category clusters, in an order of initial scanning by the OCR engine.

11. The computer-implemented method of claim 1, wherein the automatically obtaining the image comprises automatically providing images associated with each digitized menu item based on an item name and an item description, wherein a dataset generated by curating digitized dish images, dish names and descriptions from multiple sources, generating a similarity index between each dish in the dataset and the digitized menu item, according to the dish name and description, by vectorizing each feature point and generating a vector similarity index.

12. A non-transitory computer-readable medium including executable instructions for automatically generating a digitized menu, the instructions comprising:
receiving an image associated with a non-digitized menu;
performing an optical character recognition (OCR) operation on the received image, to identify characters and strings of characters comprising one or more words, to generate a text-readable document;
determining whether the received image is skewed to generate a determination;
for the determination providing an indication that the received image is skewed, performing skew detection and skew correction;
clustering the identified characters and strings of characters to generate a clustered text-readable document;
classifying the clusters, and associating the classified clusters to generate a classified, associated text-readable document;
for one or more items on the classified, associated text-readable document, automatically obtaining an associated image; and
providing the digitized menu comprising the associated image and the classified, associated text-readable document.

13. The non-transitory computer-readable medium of claim 12, wherein the performing the OCR operation comprises an OCR engine initially detecting all text in the received image, and recognizing the characters and the strings of characters that comprise the one or more words in the menu, and distinguishing each of the separate one or more words present in the image, so as to discern each of the characters, and correctly identify each of the characters.

14. The non-transitory computer-readable medium of claim 13, wherein the performing the skew detection comprises calculating a slope of bounding boxes associated with the detected texts, calculating a mode of the slopes of the bounding boxes and an angle of rotation associated with the slopes, and determining a presence of the skew for the bounding boxes having an angle of rotation at an angle of the image, based on the mode of the slopes not being equal to 0.

15. The non-transitory computer-readable medium of claim 14, wherein the skew correction comprises initially augmenting dimensions of the image according to the angle of rotation, such that no information is cropped from the received image, rotating the received image by the angle of rotation, performing the OCR on the rotated received image, and obtain new coordinates for the bounding boxes of the text.

16. The non-transitory computer-readable medium of claim 12, wherein the clustering comprises applying a geometric approach dependent on coordinates of the bounding boxes of each of the words, based on different x thresholds and y thresholds to determine which of the words should be associated, wherein the words that have coordinates which are close together in x and y axes are in the same line and are clustered together.

17. The non-transitory computer-readable medium of claim 16, wherein for the y threshold, the words in the same line may overlap along the y-axis of the bounding boxes, and further comprising comparing the y-coordinates of one of the bounding boxes and an adjacent one of the bounding boxes, checking if a height of the bounding boxes for each of the words in the line is not within a prescribed percentage of each other to separate into plural clusters, and wherein the x threshold is dependent on a multiple of the median of an average length per character for the words.

18. The non-transitory computer-readable medium of claim 12, wherein the classifying comprises classifying each of the clusters is classified as one of price, menu item, menu description, or category, and the classifying as the price comprises taking a threshold on a ratio of a number of characters that are digits to a total number of characters in a cluster, and setting an upper limit on the total number of characters in the cluster, and further, wherein for the clusters that are not classified as the price, an operation is performed to dynamically determine distance thresholds between the clusters to that are not classified as the price to classify as a menu item or a menu description.

19. The non-transitory computer-readable medium of claim 12, wherein the association comprises associating a cluster that is a menu item with respective next corresponding clusters that are menu description, price and category clusters, in an order of initial scanning by the OCR engine.

20. The non-transitory computer-readable medium of claim 12, wherein the automatically obtaining the image comprises automatically providing images associated with each digitized menu item based on an item name and an item description, wherein a dataset generated by curating digitized dish images, dish names and descriptions from multiple sources, generating a similarity index between each dish in the dataset and the digitized menu item, according to the dish name and description, by vectorizing each feature point and generating a vector similarity index.
